(19) United States
(12) Patent Application Publication
(10) Pub. No.: US 2015/0153626 A1
(43) Pub. Date: Jun. 4, 2015

(54) ELECTRONIC PAPER MODULE, ELECTRONIC PAPER DISPLAY DEVICE AND MANUFACTURING METHOD OF ELECTRONIC PAPER

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventor: Peizhi Cai, Beijing (CN)

(21) Appl. No.: 14/347,104

(22) PCT Filed: Aug. 27, 2013
(86) PCT No.: PCT/CN2013/082332

§ 371 Date: Mar. 25, 2014

(30) Foreign Application Priority Data
May 29, 2013 (CN) 201310206908.3

(51) Int. Cl. G02F 1/167; G02F 1/1339

(52) U.S. Cl. CPC G02F 1/167; G02F 1/1339; G02B 1/14

(57) ABSTRACT

An electronic paper module, an electronic paper display device and a manufacturing method of an electronic paper module are disclosed, and the electronic paper module including an array substrate and an electronic ink containing layer, a transparent sealant, a transparent conductive film layer and a protective layer disposed in order on the array substrate, the electronic ink containing layer is provided with electronic ink containing holes therein, the electronic ink containing holes are provided with electronic ink therein. The transparent sealant is used to encapsulate the electronic ink containing layer, and the transparent conductive film layer is disposed over the transparent sealant. Because no microcapsule structure is required in the electronic paper module, a process flow is simplified, and production costs are effectively reduced.

### TECHNICAL FIELD

Embodiments of the present invention relate to an electronic paper module, an electronic paper display device and a manufacturing method of the electronic paper module.

### BACKGROUND

Electronic paper is a technology that realizes black-white or color display by driving electronic ink with an array substrate. Due to its advantages of extremely low power consumption and suitability for human eye reading, electronic paper has been drawing attention of people. Electronic paper typically realizes display by means of micro-cup technology or micro-capsule technology. Whatever electronic paper display technology is used, display of text information requires driving. Array substrates generally adopt active matrix driving. For example, the thin film transistor (TFT) technology is one of the technologies for realizing active matrix driving. Of course, besides the active matrix driving, passive driving technologies may also be used to drive electronic paper display.

FIG. 1 is a structural representation of an electronic paper module based on electronic ink micro-capsule technology in a black-white display state. The electronic paper module includes in order an array substrate 10, an electronic paper film 8 and an upper substrate 6, and an adhesive layer 9 is provided between the electronic paper film 8 and the array substrate 10 for affixing the electronic paper film 8 to the array substrate 10. The electronic paper film 8 includes a layer of transparent film and micro-capsules disposed therein. A micro-capsule includes a capsule wall 3 and electronic ink contained therein. The electronic ink includes white particles 1, black particles 4, and transparent electrophoresis liquid 2. The capsule wall 3 encapsulates the electronic ink to form a micro-capsule. A transparent conductive film 7 is disposed between the upper substrate and the electronic paper film 8. In general, a PET (polyethylene terephthalate) plate is used as the upper substrate 6; and further, a protective film 5 may be disposed on the upper substrate for further protecting the electronic paper module.

As illustrated in FIG. 2, in manufacturing of the above-mentioned electronic paper module, typically white particles and black particles for display are dispersed into a transparent electrophoresis liquid and encapsulated by a capsule wall to form micro-capsules. The micro-capsules are bonded to a transparent film by an adhesive agent to form an electronic paper film, and this electronic paper film is disposed on an array substrate via an adhesive layer. Thereafter, the upper substrate provided with a transparent conductive film (such as ITO film) is attached onto the electronic paper film. Then the protective film is attached to the upper substrate to form the electronic paper module.

However, the above-mentioned process for manufacturing electronic paper based on micro-capsule technology is complicated and requires complex operations illustrated in FIG. 2: making an electronic paper film and then attaching the film to an array substrate, further attaching the upper substrate, and finally encapsulating. This results in high costs and reduces competitive power.

### SUMMARY

Embodiments of the present invention provide an electronic paper module, an electronic paper display device and a manufacturing method of the electronic paper module that can simplify the technical process and reduce the costs.

One aspect of the present invention provides an electronic paper module comprising an array substrate and an electronic ink containing layer, a transparent sealant, a transparent conductive film layer and a protective layer disposed in order on the array substrate, the electronic ink containing layer is provided with electronic ink containing holes therein, the electronic ink containing holes are provided with electronic ink therein, the transparent sealant is configured to encapsulate the electronic ink containing layer, and the transparent conductive film layer is disposed over the transparent sealant.

For example, in the electronic paper module, the electronic ink containing layer may be a resin layer.

For example, in the electronic paper module, pixel electrodes may be disposed between the array substrate and the electronic ink containing layer.

For example, in the electronic paper module, the electronic ink containing holes may be disposed over the pixel electrodes.

For example, in the electronic paper module, a number of the electronic ink containing holes may be one or more than one; and/or a cross-section of the electronic ink containing holes may be circle or rectangle.

For example, in the electronic paper module, the electronic ink containing holes may be disposed perpendicularly to the electronic ink containing layer.

For example, in the electronic paper module, the electronic ink containing holes may be through holes or blind holes.

For example, in the electronic paper module, where the electronic ink containing holes are through holes, a protective layer is provided between the electronic ink containing layer and the array substrate, or a protective layer is provided between the electronic ink containing holes and the array substrate; where the electronic ink containing holes are blind holes, blind ends of the electronic ink containing holes face the array substrate.

Another aspect of the present invention provides an electronic paper display device including the above-mentioned electronic paper module.

Yet another aspect of the present invention provides a manufacturing method of an electronic paper module comprising:

S11, forming an electronic ink containing layer on an array substrate;

S12, forming electronic ink containing holes in the electronic ink containing layer;

S13, providing electronic ink in the electronic ink containing holes;

S14, encapsulating the electronic ink containing layer formed with the electronic ink containing holes with a transparent sealant;

S15, forming patterns including a transparent conductive film layer on the transparent sealant; and

S16, forming a protective film on the transparent conductive film layer.

For example, in the method, before step S11, a step of forming the array substrate may be included, and the array substrate has pixel electrodes formed thereon.

For example, in the method, the step S12 may be: forming the electronic ink containing holes in portions of the electronic ink containing layer that correspond to pixel electrodes on the array substrate.

For example, in the method, the electronic ink containing layer may be a resin layer.

For example, in the method, step S12 may be: forming the electronic ink containing holes in the resin layer by a patterning process.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structure diagram of a conventional electronic paper module;

FIG. 2 is a manufacturing flow chart of the conventional electronic paper module;

FIG. 3 is a manufacturing flow chart of an electronic paper module according to an embodiment of the present invention;

FIG. 4 is a structure diagram of an electronic paper module according to an embodiment of the present invention;

FIG. 5 is a top view of an electronic ink containing layer according to an embodiment of the present invention.

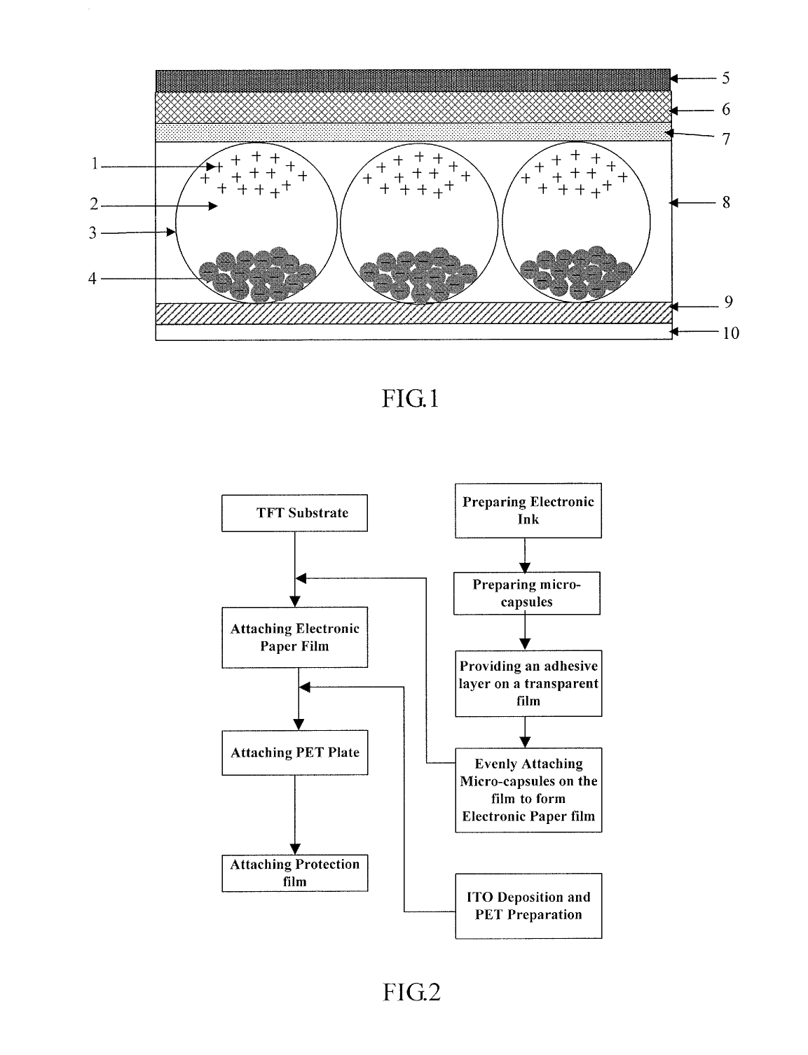

### REFERENCE NUMERALS

1. White particle; 2. Transparent electrophoresis liquid; 3. Capsule wall; 4. Black particle; 5. Protective film; 6. Upper substrate; 7. Transparent conductive film; 8. Transparent film; 9. Adhesive layer; 10. Array substrate; 11. Electronic ink containing layer; 12. Transparent sealant; 13. Electronic ink containing hole.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” “the” and the like are not intended to limit the amount, but indicate the existence of at lease one. The terms “comprises,” “comprising,” “includes,” “including,” and “contains”, “containing” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

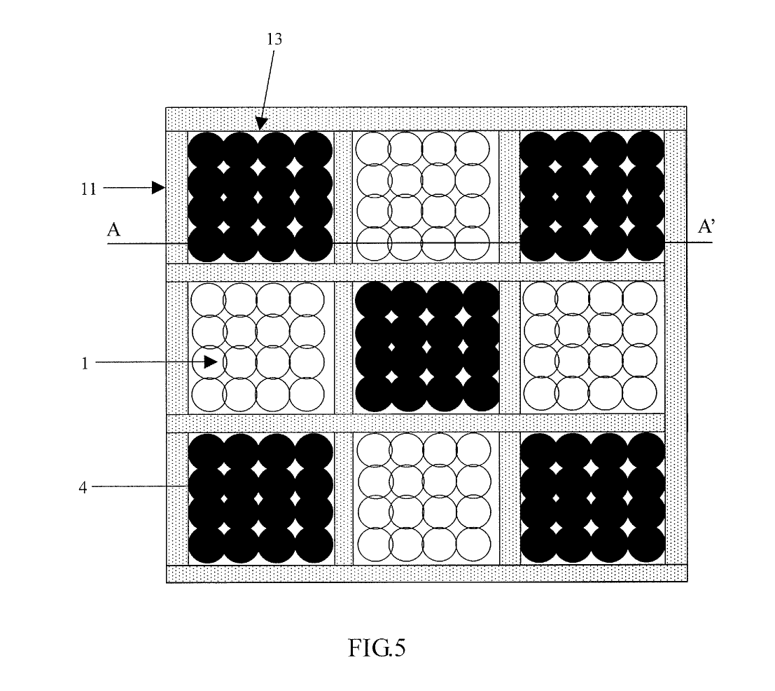

FIG. 4 is a structure diagram of an electronic paper module according to an embodiment of the present invention; FIG. 5 is a top view of an electronic ink containing layer according to an embodiment of the present invention. For example, FIG. 4 is a sectional view along line A-A′ in FIG. 5.

As illustrated in FIG. 4, the electronic paper module provided in the embodiment of the present invention includes an array substrate 10 and an electronic ink containing layer 11, a transparent sealant 12, a transparent conductive film layer 7 and a protective layer 5 disposed in this order on the array substrate 10. The electronic ink containing layer 11 is provided with electronic ink containing holes 13 therein, in which electronic ink (EI) is provided, the transparent sealant 12 is adapted to encapsulate the electronic ink containing layer 11, and the transparent conductive film layer 7 is disposed (for example directly disposed) over the transparent sealant 12. Referring to the embodiment illustrated in FIG. 5, the array substrate 10 includes a plurality of pixel units arranged in an array.

As illustrated in FIG. 4, the electronic ink EI may include white particles 1, transparent electrophoresis liquid 2, black particles 4 to realize black-white display of the electronic paper module. It is to be understood that it is also possible to change the transparent electrophoresis liquid to a colorful electrophoresis liquid (by adding dyes and/or pigments), or substitute color particles for black and white particles, so as to realize color display of electronic paper, which will not be described in detail here.

The electronic ink containing layer 11 may be a resin layer with a thickness of for example 5˜15 μm.

The array substrate may adopt an active driving or passive driving method, for example, the thin film transistor (TFT) driving technology in the active matrix driving technologies.

Whatever driving technology the array substrate adopts, pixel electrodes 14 are required between the array substrate and the electronic ink containing layer. A voltage is formed between the pixel electrodes 14 and the transparent conductive film 7 serving as common electrodes to drive black and white particles to move in the vertical direction of the array substrate and realize black-white display. The principle for electronic paper to realize black-white display or color display is well known in the art, which will not be repeated here. The pixel electrodes 14 are disposed corresponding to pixel units.

For example, the electronic ink containing holes 13 are formed over the pixel electrodes 14. For example, each electronic ink containing hole 13 corresponds to one pixel electrode 14, or a plurality of electronic ink containing holes 13 correspond to one pixel electrode 14.

In the electronic paper module according to an embodiment of the present invention, for example, the number of the electronic ink containing holes 13 may be one or more than one, and the cross-section may be in a shape of circle, rectangle, equiangular triangle, regular hexagon, which is not limited thereto in the present invention. The electronic ink containing holes 13 may be disposed perpendicularly to the electronic ink containing layer 11. The electronic ink containing holes 13 may be through holes or blind holes. When the electronic ink containing holes 13 are through holes, it is required to dispose a protective layer (not shown) between the electronic ink containing layer 11 and the array substrate 10 or dispose a protective layer (not shown) between the electronic ink containing holes 13 and the array substrate 10, it is enough for the protective layer to ensure that the performance of electronic ink and the array substrate are both not influenced. When the electronic ink containing holes 13 are blind holes, the blind ends of the electronic ink containing holes 13 may face the array substrate 10, as illustrated in FIG. 4. In general, the depth of electronic ink containing holes 13 is equivalent to the thickness of electronic ink containing layer 11; and the cross-sectional area of an electronic ink containing hole 13 may vary with a different size of the electronic paper display screen, and is generally slightly smaller than an area of one pixel.

One embodiment of the present invention may be as illustrated in FIG. 5. In FIG. 5, square electronic ink containing holes 13 are provided perpendicular to the electronic ink containing layer 11, and white particles 1 and black particles 4 are contained in the electronic ink containing holes 13 to realize normal black-white display.

An embodiment of the present invention further provides an electronic paper display device including the above-mentioned electronic paper module.

The electronic paper module in the embodiment of the present invention has no micro-capsule structure, an electronic ink containing layer 11 may be formed directly on the array substrate 10 to contain electronic ink by means of electronic ink containing holes 13 therein, and therefore the process flow is simplified, production efficiency is improved, and production costs are effectively reduced. In addition, the electronic paper module needs no upper substrate (for example PET plate) 6, which further saves costs and enables it to become slighter and thinner. Furthermore, with the electronic paper display device including the electronic paper module according to an embodiment of the present invention, the process flow is also simplified, the production efficiency is improved and the production costs are effectively reduced, and costs may be further saved and it may become slighter and thinner since the upper substrate 6 is not needed.

Another embodiment of the present invention provides a manufacturing method of electronic paper module, including the following steps:

S11. Forming an electronic ink containing layer on an array substrate.

The forming method in this step may be deposition, coating, sputtering and thermal evaporation, which is not limited here.

S12. Forming electronic ink containing holes in the electronic ink containing layer.

The forming method in this step may be any suitable process selected according to the material of electronic ink layer.

S13. Providing electronic ink in the electronic ink containing holes.

The electronic ink may be provided in the electronic ink containing holes by means of dropping, spraying or the like in this step. The electronic ink may be prepared separately or prepared in situ and then provided into the electronic ink containing holes.

S14. Encapsulating the electronic ink containing layer formed with the electronic ink containing holes with a transparent sealant.

For example, the material for the transparent sealant in this step is mainly epoxy resin. Since transmission of incident light and reflected light is necessary for realizing display, the sealant must be transparent.

S15. Forming patterns including a transparent conductive film layer on the transparent sealant.

The transparent conductive film layer may be indium tin oxide (ITO) and indium zinc oxide (IZO), and the forming methods may be deposition, sputtering, thermal evaporation or the like.

S16. Forming a protective film on the transparent conductive film layer.

Any existing available material may be used for the protective film, which will not be described here.

Furthermore, before step S11, a step of forming an array substrate may be included, and the array substrate has pixel electrodes formed thereon.

For example, one example of step S12 is: forming electronic ink containing holes in portions of the electronic ink containing layer that correspond to pixel electrodes on the array substrate.

If the electronic ink containing layer in the above-mentioned manufacturing method is a resin layer, electronic ink containing holes may be formed in the resin layer by a patterning process.

In the present disclosure, the patterning process may include only photolithographic process, or may include photolithographic process and etching step, also may further include processes for forming predetermined patterns such as printing, ink jetting or the like as required. The photolithographic process refers to the process for forming patterns with photoresist, mask and exposure machine, including technical processes such as film formation, exposure and development. A corresponding patterning process may be selected depending on the structure formed in the present invention.

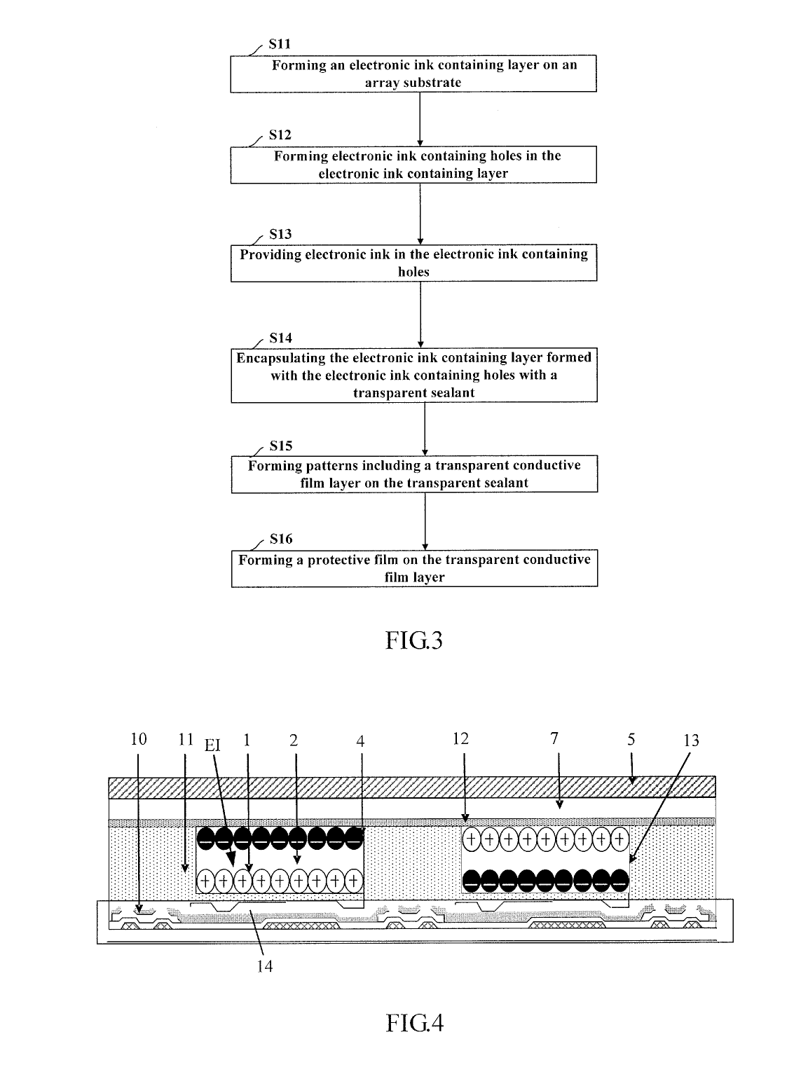

It is known in connection with FIGS. 3 and 4, the electronic ink containing layer 11 of a resin material may be deposited on the array substrate 10 and electronic ink containing holes 13 for containing electronic ink are formed by a patterning process in the electronic ink containing layer 11. After dropping electronic ink into the electronic ink containing holes 13, the electronic ink containing layer 11 formed with the electronic ink containing holes 13 is encapsulated with the transparent sealant 12. Then a transparent conducting layer such as transparent ITO film layer is deposited over the transparent sealant 12, and next a protective film 5 is attached on the transparent conducting layer to complete the electronic paper module.

As can be seen, in manufacturing of the electronic paper module in an embodiment of the present invention, no micro-capsule structures are manufactured, an electronic ink containing layer 11 is formed directly on the array substrate 10 to contain electronic ink by means of electronic ink containing holes 13 therein, and therefore process flow is simplified, production efficiency is improved, and production costs are effectively reduced. In addition, no upper substrate (for example a PET plate) 6 is manufactured, which further saves costs and enables it to become slighter and thinner.

The electronic paper module and the electronic paper display device in the embodiments of the present invention have no micro-capsule structures, an electronic ink containing layer is deposited directly on the array substrate to contain electronic ink by means of electronic ink containing holes therein in manufacturing of the electronic paper module, therefore process flow is simplified, production efficiency is improved, and production costs are effectively reduced. In addition, the upper substrate commonly used in the conventional technology is not needed, which further saves costs and enables it to become slighter and thinner.

What are described above is related to the illustrative embodiments of the disclosure only and not limitative to the scope of the disclosure; the scopes of the disclosure are defined by the accompanying claims.

1. An electronic paper module comprising an array substrate and an electronic ink containing layer, a transparent sealant, a transparent conductive film layer and a protective layer disposed in order on the array substrate,
wherein the electronic ink containing layer is provided with electronic ink containing holes therein, the electronic ink containing holes are provided with electronic ink therein, the transparent sealant is configured to encapsulate the electronic ink containing layer and the transparent conductive film layer is disposed over the transparent sealant.

2. The electronic paper module of claim 1, wherein the electronic ink containing layer is a resin layer.

3. The electronic paper module of claim 1, wherein pixel electrodes are disposed between the array substrate and the electronic ink containing layer.

4. The electronic paper module of claim 3, wherein the electronic ink containing holes are disposed over the pixel electrodes.

5. The electronic paper module of claim 1, wherein
a number of the electronic ink containing holes is one or more than one; and/or
a cross-section of the electronic ink containing holes is circle or rectangle.

6. The electronic paper module of claim 1, wherein the electronic ink containing holes are disposed perpendicularly to the electronic ink containing layer.

7. The electronic paper module of claim 1 wherein the electronic ink containing holes are through holes or blind holes.

8. The electronic paper module of claim 7, wherein where the electronic ink containing holes are through holes, a protective layer is provided between the electronic ink containing layer and the array substrate, or a protective layer is provided between the electronic ink containing holes and the array substrate;
wherein the electronic ink containing holes are blind holes, blind ends of the electronic ink containing holes face the array substrate.

9. An electronic paper display device comprising the electronic paper module of claim 1.

10. A manufacturing method of an electronic paper module comprising:
S11, forming an electronic ink containing layer on an array substrate;
S12, forming electronic ink containing holes in the electronic ink containing layer;
S13, providing electronic ink in the electronic ink containing holes;
S14, encapsulating the electronic ink containing layer formed with the electronic ink containing holes with a transparent sealant;
S15, forming patterns including a transparent conductive film layer on the transparent sealant; and
S16, forming a protective film on the transparent conductive film layer.

11. The method of claim 10, further comprising, before step S11, a step of forming the array substrate having pixel electrodes formed thereon.

12. The method of claim 10, wherein step S12 comprises:
forming the electronic ink containing holes in portions of the electronic ink containing layer that correspond to pixel electrodes on the array substrate.

13. The method of claim 10, wherein the electronic ink containing layer is a resin layer.

14. The method of claim 13, wherein step S12 is forming the electronic ink containing holes in the resin layer by a patterning process.

15. The electronic paper module of claim 3, wherein the electronic ink containing holes are disposed perpendicularly to the electronic ink containing layer.

16. The electronic paper module of claim 3, wherein the electronic ink containing holes are through holes or blind holes.

17. The electronic paper module of claim 16, wherein where the electronic ink containing holes are through holes, a protective layer is provided between the electronic ink containing layer and the array substrate, or a protective layer is provided between the electronic ink containing holes and the array substrate;
wherein the electronic ink containing holes are blind holes, blind ends of the electronic ink containing holes face the array substrate.

18. The electronic paper module of claim 4, wherein the electronic ink containing holes are disposed perpendicularly to the electronic ink containing layer.

19. The electronic paper module of claim 4, wherein the electronic ink containing holes are through holes or blind holes.

20. The electronic paper module of claim 19, wherein where the electronic ink containing holes are through holes, a protective layer is provided between the electronic ink containing layer and the array substrate, or a protective layer is provided between the electronic ink containing holes and the array substrate;
wherein the electronic ink containing holes are blind holes, blind ends of the electronic ink containing holes face the array substrate.
